(19) United States
(12) Patent Application Publication
(10) Pub. No.: US 2021/0075758 A1
(43) Pub. Date: Mar. 11, 2021

(54) SERVER AND USER TERMINAL FOR SUPPORTING MANAGEMENT OF SOCIAL NETWORK

(71) Applicant: TWINNY Co., Ltd., Daejeon (KR)

(72) Inventors: Hongseok CHEON, Daejeon (KR); Young Seok CHEON, Ansan-si, Gyeonggi-do (KR); Sang Hwi LEE, Uiwang-si Gyeonggi-do (KR)

(21) Appl. No.: 16/772,148

(22) PCT Filed: Dec. 13, 2018
(86) PCT No.: PCT/KR2018/015822

§ 371 Date: Jun. 11, 2020

(30) Foreign Application Priority Data
Dec. 15, 2017 (KR) 10-2017-0173200

(51) Int. Cl. H04L 12/58; G06F 16/28; G06F 16/9536

(52) U.S. Cl. CPC H04L 51/32; G06F 16/9536; G06F 16/288

(57) ABSTRACT

A server for supporting management of a social network among users is proposed. Through execution of a server-side social network relationship management program, the server stores user personal information, and personal data registered by the users, in a database by matching with user identification information; stores group information, and group data registered by members of a group, in the database by matching with group identification information; and stores friend relationship information, and friend relationship data registered by the users establishing the friend relationship, by matching friend relationship identification information.

### TECHNICAL FIELD

The present invention relates to a server and a user terminal for supporting management of a social network of users.

### BACKGROUND

With the rapid development of information and communication technology and the advent of smart devices, various types of social network services (SNS) applying those technologies have been used. In particular, a chat service in which a plurality of users open chat rooms and exchange messages in real time in the opened chat room is widely used. These chat services are evolving to have more diverse functions according to user needs.

For example, such a chat service provides a function that guides users to establish a friend relationship with a new user on the basis of a contact information previously stored in a smart device, or a function that substantially replaces a community service such that several users having the same interests exchange information through the chat rooms, so that the chat service is widely used as a tool to manage various human relationships between the users offline or online.

However, although such a chat service provides services to some extent for social groups through the chat room, the chat service has a deficiency in satisfying all the various meeting service functions required by offline or online meetings organized according to various organizational purposes.

In addition, although a mobile-based meeting service is widely used as a form of replacing existing web-based meeting services, in the case of such a meeting service, there is a deficiency in supporting the chat function among members.

Accordingly, the present invention aims to provide a server and a user terminal that support a new concept of social network management capable of effectively supporting not only the social network management between individuals but also the social network management in groups such as meetings.

In this regard, in Korean Patent Application Publication No. 10-2004-0082023 (Name of invention: STORAGE MEDIUM STORING MESSENGER PROGRAM HAVING COMMUNITY LINKING FUNCTION AND METHOD FOR PROVIDING MESSENGER-LINKED COMMUNITY SERVICE USING THE MESSENGER PROGRAM), a configuration is disclosed where position information of one or more online communities is linked to a messenger program installed on a user terminal system, by using one or more of a community registration function provided by the messenger program, and a community registration function provided on the corresponding community web page. Through this functionality, users do not need to visit and log in one by one to various online community websites to which the users have subscribed, and are able to access various online community sites easily through the messenger program always running.

### DISCLOSURE

### Technical Problem

The objective of an exemplary embodiment of the present invention is to provide a server and a user terminal that support social network management that enables users to integrally manage both social networks between individuals, and social networks in groups.

However, the technical problem to be solved by the present exemplary embodiment is not limited to the above technical problems, and yet another technical problems may exist.

### Technical Solution

According to an aspect of the present invention for achieving the above technical problem, a server for supporting management of a social network among users includes: a communication module performing data communication; a memory storing a server-side social network relationship management program; and a processor executing the server-side social network relationship management program. In response to executing of the program, the processor stores user personal information, and personal data registered by the users, in a database by matching with user identification information; stores group information, and group data registered by members of a group, in the database by matching with group identification information; and stores friend relationship information, and friend relationship data registered by the users establishing a friend relationship, by matching with friend relationship identification information. At this time, the personal data includes one or more of a friend list, a personal schedule, a personal memo, and digital content, which are registered by the users; the group data includes one or more of a group schedule, a group post, group chat data, and the digital content, which are registered by the members of the group; the friend relationship information includes identification information of two users establishing the friend relationship; and the friend relationship data includes one or more of a schedule between friends, a post between friends, chat data between friends, exchange between friends, and the digital content, which are registered by the two users.

In addition, according to another aspect of the present invention, a user terminal performing social network relationship management includes: a communication module performing data communication; a display unit; a memory storing a user-side social network relationship management program; and a processor executing the user-side social network relationship management program stored in the memory. In response to the executing of the program, the processor stores personal information and personal data of a user in a local database; stores friend relationship information and friend relationship data where a friend relationship with the user is established, in the local database by matching with friend relationship identification information; stores group information and group data in the local database by matching with identification information of a group where the user is registered as a member of the group; and outputs the personal data, the friend relationship data, or the group data through a user interface displayed on the display unit. At this time, the personal data includes one or more of a friend list, a personal schedule, a personal memo, and digital content, which are registered in a social network management support server by the user; the group data includes one or more of a group schedule, a group post, group chat data, and the digital content, which are registered in the social network management support server by members of a group; the friend relationship information includes identification information of two users establishing the friend relationship; and the friend relationship data includes one or more of a schedule between friends, a post between friends, chat data between friends, exchange between friends, and the digital content, which are registered by the two users.

### Advantageous Effects

According to one of the above-described problem solutions of the present invention, the social networks between individuals and the social networks in groups may be integrally managed, thereby improving user convenience.

In particular, the social network management support server and user terminal according to the present invention constitute a system to manage not only the friend relationship between individual users, but also the friend relationship between group members, and enable the users to efficiently perform the management through a convenient user interface.

### BRIEF DESCRIPTION OF THE DRAWINGS

FIG. 1 is a block diagram of a social network management system according to an exemplary embodiment of the present invention.

FIG. 2 is a view showing a user interface according to the exemplary embodiment of the present invention.

FIGS. 3A to 3D are views each showing the user interface according to the exemplary embodiment of the present invention.

FIGS. 4A to 4D are views each showing content of a friend interface displayed on the user interface according to the exemplary embodiment of the present invention.

FIGS. 5A to 5D are views each showing content of a group interface displayed on the user interface according to the exemplary embodiment of the present invention.

### DESCRIPTION OF THE MAIN NUMERALS IN THE DRAWINGS

100: social network management support server

110: memory

120: communication module

130: processor

140: database

200, 300: user terminal

210: memory

220: communication module

230: display unit

240: processor

250: local database

410: menu interface

420: content interface

### BEST MODE

Hereinafter, exemplary embodiments of the present invention will be described in detail with reference to the drawings accompanied so that those skilled in the art may easily implement the present invention. However, the present invention is not limited to the exemplary embodiments described herein and may be embodied in many different forms. In addition, in order to clearly describe the present invention in the drawings, parts irrelevant to the description are omitted, and like reference numerals designate like elements throughout the specification.

In addition, In the following description with reference to the drawings, even in the element designated by the same names, the drawing numerals may vary depending on the drawings, and the drawing numerals are merely described for convenience of description, and the concepts, features, functions, or effects of each element are not to be limited to interpretation by the corresponding drawing numbers.

Throughout the description, it will be further understood that, when a part is said to “include” or “comprise” a certain component, it means that it may further include or comprise other components, but does not exclude other components unless the context clearly indicates otherwise, and does not preclude the presence or addition of one or more other features, integers, steps, operations, elements, components, and/or groups thereof.

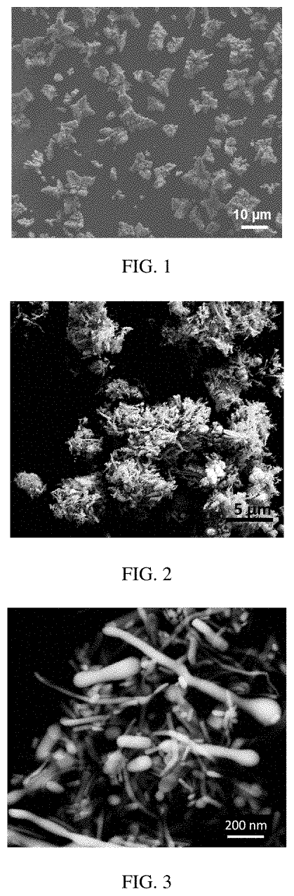

FIG. 1 is a block diagram of a social network management system according to an exemplary embodiment of the present invention.

The illustrated social network management system 10 includes a social network management support server 100 and a plurality of user terminals 200 and 300 connected to the server.

The social network management support server 100 (hereinafter referred to as “server”) includes a memory 110, a communication module 120, a processor 130, and a database 140.

In the memory 110, a server-side social network relationship management program is stored. At this time, the memory 110 refers to a generic term for both a non-volatile storage device that keeps stored information even when power is not supplied and a volatile storage device that requires power to maintain the stored information. Moreover, in addition to the social network relationship management program, various programs and data are stored in the memory 110, which may be processed by the processor 130.

The communication module 120 connects the user terminals 200 and 300, and the server 100 to each other through a network, thereby performing various data transmission and reception processing. The communication module 120 performs various types of network communication connections such as Wi-Fi, Bluetooth, Internet, LAN (Local Area Network), Wireless LAN (Wireless Local Area Network), WAN (Wide Area Network), PAN (Personal Area Network), 3G, 4G, LTE, etc., but is not limited thereto.

The processor 130 executes the server-side social network relationship management program stored in the memory 110, and additionally performs various processes for the operation of the server 100. The processor 130 manages the database 140 according to the execution of the server-side social network relationship management program. At this time, the database 140 includes a personal DB in which user personal data is stored, a group DB in which group data of each group is stored, and a friend relationship DB in which friend relationship data is stored for each of friend relationship.

The processor 130 generates user identification information for distinguishing each user, and stores user personal information, and personal data registered by the user, in the database 140 by matching with the user identification information.

At this time, the user personal information includes one or more of a user ID, contact information (i.e., address, email address, phone number, etc.), a profile image, and nickname information, and other information may be additionally stored as needed.

Personal data includes one or more of a friend list registered by user, a personal schedule, a personal memo, and digital content. The friend list refers to a list of users for which a friend relationship is established through a social network management service, and a personal schedule refers to a personal schedule of a user, input by the user through a schedule management tool. The personal memo may refer to various text data, map data, or other various multimedia data, input by the user through a memo management tool. Digital content refers to pictures, videos, or music content, which are taken by the users by utilizing user terminals or various other multimedia recording tools.

Such personal data is transmitted to the server 100 through the user terminals 200 and 300, then is managed by the server 100, and may be transmitted to each user terminal 200 and 300 at the request of the user terminals 200 and 300 afterwards.

In addition, the processor 130 stores the group information and group data, which are registered by the group members, in the database 140 by matching with the group identification information. The present invention has a technical feature in providing a social network management service based on a friend relationship between each individual user, together with a meeting-based social network management service as well. To this end, a separate database for managing groups in which a plurality of users are registered as members is allowed to be built and integrally managed.

That is, when one group is created for each meeting, the processor 130 generates group identification information for distinguishing each group, and stores various group data uploaded by group members, in the database 140.

At this time, the group information includes one or more of a group name, introduction or description of the group, information about group members, a group profile image, and nickname information of group members.

In addition, the group data includes one or more of a group schedule, a group post, group chat data, and digital content, which are registered by the group members. The group schedule refers to various group-related functions, events, meeting schedules, etc., input through the schedule management tool by the corresponding group members. The group post refers to various text data, map data, or other various multimedia data, input through a post writing tool by the corresponding group members, and may include free posts, notices, etc., written by each member. The digital content refers to pictures, videos, or music content, which are taken by the group members by utilizing user terminals or various other multimedia recording tools.

In addition, the processor 130 generates friend relationship identification information when a new friend relationship is created, and stores friend relationship identification data registered by a user composing friend relationship information and the friend relationship, by matching with the friend relationship identification information.

At this time, the friend relationship information includes identification information of two users constituting the friend relationship. In addition, the friend relationship information includes information on a type of friend relationship establishment. In the present invention, two main types of friend relationships are distinguished.

That is, the established type of friend relationship is divided into a type of friend relationship between individuals in which a friend relationship is established through an acceptance action for the friend relationship establishment by two users, and a type of friend relationship between group members in which the friend relationship is automatically established between group members when being registered as a group member.

For example, in the type of friend relationship between individuals, when the two users have mobile phone contact information with each other, the friend relationship may be established automatically or in accordance with an acceptance procedure between the two users. Alternatively, when the contact information of a second user is stored in the user terminal of a first user, but the contact information of the first user is not stored in the user terminal of the second user, the server 100 may recommend the first user as a friend to the second user. Through this process, a friend relationship between individuals may be formed.

Meanwhile, in the present invention, a friend relationship is automatically created for a group member, and a chat service is provided based on this functionality, thereby supporting communication between the group members to be more smoothly performed.

To this end, a friend relationship is automatically established between group members at the time of being registered as a group member. For example, as a user is registered as a first group member, the server 100 automatically establishes the friend relationship between the user and each first group member, who has not been established the friend relationship with the corresponding user.

According to this configuration, based on the information stored in the friend relationship information, it is possible to check whether an established friend relationship of two users is the friend relationship between individuals (i.e., a first friend relationship) in which the friend relationship is established through acceptance of the friend relationship establishment by the two users who have established the friend relationship, or the friend relationship between group members (i.e., a second friend relationship) automatically established into the friend relationship between group members when being registered as a group member.

Meanwhile, the friend relationship identification information is generated at the time when the friend relationship of the two users is created, and is generated regardless of the type of the friend relationship. Therefore, when the first friend relationship is already established, the second friend relationship may be additionally established, and at this time, two types of friend relationships are established by matching with the same friend relationship identification information.

Conversely, as the user is registered as a member of a group, when a friend relationship is automatically established between the user and each member of the group whose friend relationship with the corresponding user has not been established, new friend relationship identification information is generated, and thereafter, two users may separately create the friend relationship between individuals.

In addition, in the case where a second friend relationship is established between the two users whose first friend relationship has already been generated, the server 100 adds information about the second friend relationship establishment by matching with the friend relationship identification information already generated by the first friend relationship, or in the case where a first friend relationship is established between the two users whose second friend relationship has already been generated, the server 100 adds information about the first friend relationship establishment by matching with the friend relationship identification information already generated by the second friend relationship.

Meanwhile, the friend relationship data includes one or more of a schedule between friends registered by two users, a post between friends, chat data between friends, exchange between friends, and digital content. The schedule between friends refers to various schedules between friends, input through the schedule management tool by the user in the friend relationship. The post between friends refers to various text data, map data, or various other multimedia data, input through the post writing tool by the user in the friend relationship, and may include free posts written by each user. The exchange between friends refers to a gift item, a mobile payment item, or a mobile currency, which are exchanged or scheduled to be exchanged between users by the user in the friend relationship. Through this exchange between friends, the user may manage the records of money transactions between friends, etc. The digital content refers to pictures, videos, or music content, which are taken by the users in the friend relationship by utilizing user terminals or various other multimedia recording tools.

Meanwhile, such a personal DB, group DB, and friend relation DB may be connected and managed based on user information.

That is, one or more friend relationship identification information in which the corresponding user is included as a member may be stored by matching with the identification information of each user. According to this configuration, when the friend relationship data matched with the friend relationship identification information is updated, the processor 130 checks each of the user identification information matched with the friend relationship identification information, and notifies each terminal of the user constituting a friend relationship on the basis of the user identification information that the friend relationship data has been updated. Each user terminal accesses the server 100 after receiving such an updated notification of the friend relationship data, receives the updated friend relationship data, and manages the data through the local databases 250 and 350 of each user terminal.

Similarly, one or more group identification information in which the corresponding user is registered as a group member may be stored by matching with the identification information of each user.

According to this configuration, when the group data matched with the group identification information is updated, the processor 130 checks each of the user identification information matched with the group identification information, and notifies each terminal of the user registered as a group member on the basis of the user identification information that the group data has been updated. Each user terminal accesses the server 100 after receiving such a group data update notification, receives the updated group data, and manages the data through the local databases 250 and 350 of each user terminal.

In addition, the processor 130 analyzes an instant message received by the communication module 120, and may modify fonts of the vocabulary or sentence included in the instant message.

Specifically, the processor 130 may receive an instant message that a sender intends to deliver from a sender terminal to a receiver terminal through the communication module 120, and the processor 130 may generate highlight information for emphasizing a vocabulary or sentence, which is positioned between two special symbols, in the instant message created by the sender through the sender terminal.

The highlight information may include font attributes. For example, the font attributes of the instant message may be a font type, a font style, a font thickness, a font size, and a font color, etc.

It is preferable that any one or a plurality of special symbol are included from a special symbol group including “˜, !, @, #, $, %, \hat{ }, &, *, −, _, +, =” that are easily input by the sender to a terminal. Each special symbol includes different highlight information. For example, the special symbol “!” may include highlight information to increase the font thickness, and the special symbol “@” may include highlight information for underscoring the fonts.

In addition, the user may emphasize the vocabulary or sentence of the instant message by using a plurality of special symbols, and when using the plurality of special symbols, the highlight information that each special symbol provides may be all displayed.

For example, when the special symbols “!” and “@” are used at the same time, the highlight information to increase the font thickness and generate the underline may be included.

The processor 130 may apply the font attributes included in the generated highlight information to the instant message and transmit the instant message to the receiver terminal and the sender terminal through the communication module 120.

The sender terminal or the receiver terminal receiving the highlight information or the instant message including the highlight information by the server 100 may display the instant message including the highlight information on the display unit included in the sender terminal or the receiver terminal.

At this time, the sender terminal or the receiver terminal may be allowed in advance whether to receive the highlight information. The highlight information reception permission information of the sender terminal or the receiver terminal which is allowed to receive the highlight information in advance may be the information stored in each of the sender terminal and the receiver terminal, or may be the information stored in the server 100.

The instant message emphasized according to the highlight information is described as an example below. In the case where the special symbol “@” includes highlight information that forms an underline in the font, when writing an instant message through a sender terminal, when a sender enters “@Server and user terminal for supporting management of social network@” by entering a sentence between the special symbols “@”, the instant message underlined in the “Server and user terminal for supporting management of social network” positioned between “@” may be output to a receiver terminal and a sender terminal.

Through the function of emphasizing a vocabulary and sentence in an instant message as described above, by changing the fonts, the sender may emphasize the vocabulary or sentence which is considered important when writing the instant message, and thus there is an effect of enabling the receiver to conveniently identify and easily remember the important vocabulary or sentence.

In addition, the processor 130 may generate a font designed in handwriting style of a user.

Specifically, the processor 130 may receive a handwriting style conversion request from a user terminal through the communication module 120, and when the handwriting style conversion request is received, an example sentence which is a combination of basic letters necessary to complete the user's handwriting style set data may be transmitted to the user terminal.

The user may write the example sentence, output on the display unit of the user terminal, by hand using a finger, a touch pen, etc., and retransmit the written example sentence to the processor 130 through the communication module of the user terminal.

The processor 130 may extract shapes of consonants and vowels, constituting the user's handwriting style, from the example sentence written by the user; may distinguish consonants and vowels for the letters having a final character (or final consonant) from consonants and vowels for the letters having no final character (or final consonant) differently and store; and may complete the user's handwriting style set.

The processor 130 may receive the instant message, which is created after the sender sets the handwriting style conversion to the sender terminal, through the communication module 120, and may transmit the fonts to the receiver terminal and the sender terminal after converting the fonts of the received instant message into the stored fonts of the sender's handwriting style.

The sender terminal or the receiver terminal having received the instant message converted into the fonts of the sender's handwriting style by the server 100 may display the instant message converted into the fonts of the sender's handwriting style on the display unit included in the sender terminal or the receiver terminal.

Through the function capable of converting the font of the user's instant message to the fonts of the user's handwriting style as described above, the user may create and use his or her own fonts having unique personalities, and thus satisfaction increases when chatting. In addition, when a notice or schedule is written in the user's own handwriting style, there is an effect of improving readability and memory.

The first user terminal 200 includes a memory 210, a communication module 220, a display unit 230, a processor 240, and a local database 250.

In the memory 210, a user-side social network relationship management program is stored. At this time, the memory 210 refers to a generic term for both a non-volatile storage device that keeps stored information even when power is not supplied and a volatile storage device that requires power to maintain the stored information. In addition, various programs and data are stored in addition to the social network relationship management program, which may be processed by the processor 240.

The communication module 220 connects the user terminals 200 and the server 100 to each other through a network, thereby performing various data transmission and reception processing. As for the communication module 220, the communication module 120 of the server 100 and various types of communication modules capable of performing data transmission and reception processing may be used.

The display unit 230 outputs various types of user interfaces controlled by the processor 240 to support data input and output of the user.

The processor 240 executes the user-side social network relationship management program stored in the memory 210, and also performs various processes for the operation of the user terminal 200.

The processor 240 manages the local database 250 according to the execution of the user-side social network relationship management program, and the local database 250 includes a personal DB in which user personal data is stored, a group DB in which group data of each group is stored, and a friend relationship DB in which friend relationship data is stored for each friend relationship.

At this time, in the personal DB, personal information and personal data, which are registered in the personal DB of the server 100 by the user of the user terminal 200, are stored.

In addition, in the group DB, group information and group data which are matched with the group identification information of the group in which the user of the user terminal 200 is registered as a group member, and which are received from the server 100, are stored.

In addition, in the friend relationship DB, the friend relationship information and the friend relationship data where the friend relationship with the user is established by matching with the friend relationship identification information by the user of the user terminal 200 as a member of the friend relationship, are stored.

The processor 240 outputs personal data, friend relationship data, or group data through a user interface displayed on the display unit 230. In addition, the processor 240 may output various information such as personal information, friend relationship information, or group information, which are stored in the local database 250 through the user interface.

At this time, the personal data includes one or more of a friend list, a personal schedule, a personal memo, and digital content, which are registered in the server 100 by the user. The group data includes one or more of a group schedule, a group post, group chat data, and digital content, which are registered in the server 100 by group members. In addition, the friend relationship data includes one or more of a schedule between friends, a post between friends, chat data between friends, exchange between friends, and digital content, which are registered by two users establishing a friend relationship.

In addition, the processor 240 analyzes an instant message input through the display unit 230, and may modify the fonts of vocabulary or sentence included in the instant message.

Specifically, the processor 240 may receive an instant message that the sender inputs through the display unit 230 to transmit from the sender terminal to the receiver terminal. The processor 240 may generate highlight information for emphasizing the vocabulary or sentence positioned between two special symbols in the instant message created by the sender through the sender terminal.

The highlight information may include font attributes. For example, the font attributes of the instant message may be a font type, a font style, a font thickness, a font size, and a font color, etc.

It is preferable that any one or a plurality of special symbol are included from a special symbol group including “˜, !, @, #, $, %, \hat{ }, &, *, −, _, +, =” that are easily input by the sender to the terminal. In addition, each special symbol includes different highlight information. For example, the special symbol “!” may include highlight information to increase the font thickness, and the special symbol “@” may include highlight information for underscoring the fonts.

In addition, the user may emphasize the vocabulary or sentence of the instant message by using a plurality of special symbols, and when using the plurality of special symbols, the highlight information that each special symbol provides may be all displayed. For example, when the special symbols “!” and “@” are used at the same time, the highlight information to increase the font thickness and generate the underline may be included.

The processor 240 may apply the font attributes included in the generated highlight information to the instant message to transmit to the receiver terminal through the communication module 220, or to transmit to the server 100 so as to allow the receiver terminal to receive the font attributes.

The receiver terminal having received the highlight information or the instant message including the highlight information, sent by the sender terminal, may display the instant message including the highlight information on the display unit.

At this time, the sender terminal or the receiver terminal may be allowed in advance whether to receive the highlight information. The highlight information reception permission information of the sender terminal or the receiver terminal, which is allowed to receive highlight information in advance may be the information each stored in the sender terminal and the receiver terminal, or may be the information stored in the server 100.

An example in which the instant message is emphasized according to the highlight information is described below. In the case where the special symbol “@” includes highlight information that forms an underline in a font, when creating an instant message through the sender terminal, when a sender enters “@Server and user terminal for supporting management of social network@” by entering a sentence between the special symbol “@”, the instant message underlined in the “Server and user terminal for supporting management of social network” positioned between two “@”s may be output to the receiver terminal and the sender terminal.

Meanwhile, a first user terminal may perform functions and roles as a sender terminal and a receiver terminal. A second user terminal has the same configuration and features as those of the first user terminal, and may perform roles and functions as the sender terminal and the receiver terminal.

The user terminals 200 and 300 are wireless communication devices having guaranteed portability and mobility, and may be a handheld-based wireless communication device of any kind, such as PCS (Personal Communication System), GSM (Global System for Mobile communications), PDC (Personal Digital Cellular), PHS (Personal Handyphone System), PDA (Personal Digital Assistant), IMT (International Mobile Telecommunication)-2000, CDMA (Code Division Multiple Access-2000, W-CDMA (W-Code Division Multiple Access), WiBro (Wireless Broadband Internet) terminal, a tablet PC, etc. Particularly, the user terminals 200 and 300 according to the exemplary embodiment of the present invention are smart terminals adding computer support functions, such as Internet communication and information retrieval, to portable terminals. It will be described as an example that the user terminal is a smartphone capable of being installed and executing a number of application programs desired by the user (i.e., the applications).

Hereinafter, main features of the present invention will be further described while describing a user interface according to the exemplary embodiment of the present invention.

FIG. 2 is a view showing a user interface according to the exemplary embodiment of the present invention.

As shown, the user interface 400 is divided into a menu interface 410 and a content interface 420. The user may activate a friend/group view, a chat list view, a schedule view, a notice view, an exchange view, etc., through the menu interface 410, and the result screen is displayed on the content interface 420.

The menu interface 410 performs access processing for one or more of all friends with established friend relationships, all groups registered by members, all chat data included by the user as a chat member, and all schedules of user participation. To this end, the menu interface 410 may include a friend/group view button 411, a chat view button 412, a schedule view button 413, a notice view button 414, or an exchange view button 415. However, this is an example, and some buttons may be excluded or added depending on the implementor's selection.

Meanwhile, the menu interface 410 is designated to a part of an area of the display unit, e.g., an upper area thereof, and is displayed in the form of a menu bar. The friend/group view button 411, the chat view button 412, the schedule view button 413, the notice view button 414, or the exchange view button 415 are disposed on the same menu bar. In addition, while the friend/group view button 411 is in a state of being activated, the friend list view and the group list view may be displayed on each of different screens separately, and a view switching button 416 for switching such a display state may be further included. The view switching button 416 may display a mark of “Group” indicating activation of group list view and a mark of “Friend” or “Individual” indicating activation of friend list view. When the view switching button 416 is selected while the “Group” mark is displayed, the group list view is activated, and when the view switching button 416 is selected while the “Friend” or “Individual” mark is displayed, the friend list view is activated. Such a view switching button 416 may be disposed at the lower left end of the display screen as shown in FIG. 2, but the present invention is not limited thereto, and the buttons may be changed in various forms and disposed depending on the implementor's selection.

The content interface 420 outputs a screen requested by the user according to activation of a specially fixed button included in the menu interface 410.

More details will be described with reference to the drawings.

FIGS. 3A to 3D are views each showing the user interface according to the exemplary embodiment of the present invention.

FIGS. 3A and 3B are views showing screens displayed on the content interface 420 according to the activation of the friend/group view button 411.

In FIG. 3A, the group list view is activated by a selection of the view switching button 416 while the friend/group view button 411 is activated. When the group list view is activated as shown in FIG. 3A, one or more of a list of groups to which a user is subscribed, a list of groups to which the user is invited to subscribe, and a list of recommended groups are displayed through the content interface 420.

In addition, in FIG. 3B, the friend list view is activated by the selection of the view switching button 416 while the friend/group view button 411 is activated. When the friend list view button is activated as shown in FIG. 3B, one or more of a friend list whose friend relationship has been established with a user, a list of users receiving a friend request, and a list of users recommended as a friend is displayed through the content interface 420.

FIG. 3C shows that a list of chat windows with other users where the user is included as a chat member is displayed on the content interface 420 according to activation of the chat view button 412.

At this time, the list of chat window may include a chat window for chatting with a user corresponding to the first friend relationship as well as a chat window for chatting with a user corresponding to the second friend relationship as described above. In addition, a chat window for chatting with other users whose friend relationship is not established may be included.

FIG. 3D shows that a schedule registered by the user according to the activation of the schedule view button 413, a schedule registered by the group to which the user is subscribed, and a schedule between the user and a friend who has established a friend relationship; is displayed on the content interface 420. As described above, by integrating and displaying schedules with other users connected through various causes in a single schedule table, it is possible to improve convenience of user's schedule management.

Meanwhile, the user may switch the schedule display state through schedule display selection menus 422 and 424 displayed on the content interface 420. That is, according to a selection of a personal schedule display selection menu 422, the display state may be switched so that only the schedule registered by the user is displayed, thereby performing a schedule editing through this selection. In addition, according to the selection of the entire schedule display selection menu 424, the display state may be switched so that the group schedule, the schedule between friends, and the personal schedule are integrally displayed together.

In addition, although not shown in FIGS. 3A to 3D, a list of notices posted by various groups to which the user has subscribed may be integrated and displayed according to activation of the notice view button 414. In addition, according to activation of the exchange view button 415, a list of gift items or mobile payment items that are exchanged or scheduled to be exchanged between a user and other users may be integrated and displayed. In addition, the menu interface 410 may further include an album view button (not shown), and according to activation of the album view button, digital content included in personal data, digital content included in group data, and digital content included in the friend relationship data may be integrated and displayed.

In this way, through the characteristic configuration of the user interface of the present invention, a list of various friends or groups, chat windows for chatting with various users, various schedules, and the like may be integrated and displayed on a single view. That is, through the menu interface 410, the friend/group list view, the chat view, the schedule view, the notice view, the exchange view, the album view, and the like are individually activated. Each of the content is output through the content interface 420, wherein various data generated between the user corresponding to the first friend relationship as well as the user corresponding to the second friend relationship are integrated and displayed together, thereby improving the convenience of the users.

Through the content interface 420 displayed according to the activation of the friend/group list view button 411 of the user interface 400, the user terminal 200 receives the user's request of friend registration establishment or the user's request of group member registration establishment, and transmits the request to the server 100.

In addition, through the content interface 420 displayed according to the activation of the friend/group list view button 411, the user terminal 200 transmits the corresponding personal data to the server 100 when receiving a personal data transmission request for transmission of personal data for a user established as a friend relationship. In addition, through the content interface 420 displayed according to the activation of the friend/group list view button 411, the user terminal 200 transmits the corresponding group data to the server 100 when receiving a group data transmission request for transmission of group data to members of a group to which the user has subscribed. In addition, through the content interface 420 displayed according to the activation of the friend/group list view button 411, the user terminal 200 displays personal data transmitted through the server 100 by the user terminal of a user established as a friend relationship. In addition, through the content interface 420 displayed according to the activation of the friend/group list view button 411, the user terminal 200 displays group data transmitted through the server 100 by the member of the group to which the user has subscribed.

In addition, through the content interface 420 displayed according to activation of the friend/group list view button 411, the user terminal 200 may access personal information registered by each user, or group information registered by each group, and the details of personal information and group information are as described above.

FIGS. 4A to 4D are views each showing content displayed by the friend interface in the user interface according to the exemplary embodiment of the present invention.

When a particular friend is selected from the friend list view screen described with reference to FIG. 2, a friend interface capable of accessing information related to the friend is executed. The friend interface displays friend relationship data stored by matching with the friend relationship identification information. For example, it is possible to display the schedule between friends, the post between friends, the chat data between friends, the exchange between friends, and the digital content. In addition, a profile image of the friend may be received and displayed.

To this end, the friend interface enables the user to access to various friend relationship data, such as information about a friend, chat information with a friend, a schedule between friends, and digital content between friends through a menu interface 510. As shown in FIGS. 4A to 4D, a screen requested by a user is displayed on a content interface 520 according to activation of a specially fixed button included in the menu interface 510.

In addition, the friend interface may display friend relationship information. For example, as shown in FIG. 4A, the information for a friend relationship type with the corresponding friend may be displayed through a friend type display icon 522. That is, through the color or text data of the friend type display icon 522, it may be easy to display whether the friend relationship type with the friend is the first friend relationship, the second friend relationship, or the first friend relationship and the second friend relationship.

In addition, as shown in FIG. 4A, the friend interface may display information for a common subscription group 524 together. That is, when there is a group to which a user and a friend are registered as members in common, the user and the friend are determined as having the common subscription group, and the profile image of the group is iconified and displayed, thereby enabling the user to display the common subscription group subscribed together with the corresponding friend to be more easily recognizable.

In addition, the friend interface displays a chat window for chatting with a friend on the content interface 520 according to the selection of the chat view button of the menu interface 510, as shown in FIG. 4B, thereby enabling the user to exchange chat with the friend.

In addition, the friend interface displays a schedule with a friend on the content interface 520 according to the selection of a schedule view button of the menu interface 510, as shown in FIG. 4C. The schedule between friends may be edited by the schedule management tool.

In addition, as shown in FIG. 4D, the friend interface integrates and displays other digital content such as images shared with friends on the content interface 520 according to the selection of the album view button of the menu interface 510, and allows digital content between friends to be edited through a content management tool.

Meanwhile, as shown in FIG. 4B, in the friend interface, as the chat view menu is executed, the chat window interface 528 and the chat status interface 526, which are on the content interface 520, are displayed together. At this time, a chat window (i.e., a window for chatting) capable of performing a chat with other users through a chat window interface 528 is displayed, and the status of one or more chat windows in which the user is participating is displayed through a chat status interface 526.

In addition, in the chat status interface 526, a chat window icon for displaying a chat with a user having a friend relationship and a chat window icon for displaying a chat with members of a group to which the user is subscribed as a member are displayed together. At this time, the chat status interface 526 may all display: a first chat window icon for displaying a chat with a user having a first friend relationship in which the friend relationship is established through acceptance of the friend relationship establishments of two users; a second chat window icon for displaying a chat with a user having the second friend relationship where a friend relationship is automatically established between the user and each member of the group in which no friend relationship has been established, as a user is registered as a member of any group; and a third chat window icon for displaying group chats with members of the group to which the user is subscribed as a member.

The friend interface outputs a chat window on which a chat message with other users, included in any chat room, is displayed through the chat window interface 528.

In addition, the friend interface may select at least one chat room according to a preset condition from among all the established chat rooms (i.e., a chat room in which the user is participating) to compose a chat window status list. In addition, the friend interface outputs the composed chat window status list through the chat window status interface 526. At this time, as shown in FIG. 4B, the chat status interface 526 and the chat window interface 528 are displayed on a single screen by dividing areas from each other. FIG. 4B shows an example in which the chat status interface 526 is disposed in the form of a horizontal bar, and the chat window interface 528 is disposed at the lower end of the chat status interface 526. However, the form of the chat status interface 526 and the position of the output area are not limited thereto.

In addition, when a user selection for any one of the chat window icons displayed on the chat status interface 526 is input, the friend interface displays a chat window corresponding to the chat window icon on the chat window interface 528. That is, in a state where the chat window for chatting with a first chat partner is activated, the user may easily move to a chat room of a second chat partner by selecting and inputting the chat window icon of the second chat partner, the chat window icon being displayed on the chat status interface 526. Accordingly, the chat window of the second chat partner is output on the chat window interface 528, and the updated chat window icons depending on the changed chat status are output on the chat status interface 526.

Meanwhile, the friend interface may display identification information indicating the number of new messages that the user has not checked for the chat window icon and for each of the chat window, through the chat status interface 526.

In this case, the friend interface may sort and output the order of the chat window icons displayed on the chat status interface according to the time sequence when the most recent chat message is registered. Accordingly, from the chat room where the user has moved to, the user may conveniently move continuously to the chat room where the user has originally participated or to other chat room. Accordingly, the user may move to a desired chat room by identifying and selecting the desired chat room without performing a separate process for selecting other chat room. In addition, as the chat window icon of the chat room in which the user has just participated is automatically included in the chat status interface 526, the user may return to the first chat room from any chat room where the user has moved to.

In addition, the friend interface may arrange the order of the chat window icons displayed on the chat status interface according to the descending order of the number of new messages. Therefore, the user may conveniently check the message reception status of other chat rooms without performing additional operations in order to check the entire chat room list.

For example, the chat window icon of the first chat partner with whom the user has been in a chat, just before when the user has moved to a chat window, may be displayed being sorted in the first order in the chat window interface 528 after when the user has moved to the chat room. In addition, the remaining chat window icons may be sorted and displayed according to the order in which the number of currently unchecked new messages is greatest. In the above description, it is explained that a method of arranging the chat window icons is applied at the same time based on the time the most recent chat message is registered and the number of new messages, but it is also possible to apply in such a way that each or any one of the two methods has priority in order. In addition, the arrangement method of the chat window icon is not limited thereto.

FIGS. 5A to 5D are views each showing content in which a group interface is displayed on the user interface according to the exemplary embodiment of the present invention.

When a specific group is selected on the group list view screen described with reference to FIG. 2 as before, the group interface capable of accessing information related to the corresponding group is executed. The group interface displays the stored group data by matching with the group identification information. For example, a group schedule, a group post, group chat data, and digital content may be displayed. In addition, it is possible to receive and display the profile image of the corresponding group.

To this end, the group interface may enable the user to access to various group data such as information about the group, chat information with group members, a group schedule, and digital content of the group through a menu interface 610. As shown in FIGS. 5A to 5D, the screen requested by the user is output to a content interface 620 according to activation of a specially fixed button included in the menu interface 610.

When a specific group is selected on the group list view screen described with reference to FIG. 2, the group interface provides a menu for accessing a group profile image 621, a group notice 622, voting information in progress in the group 623, and group album information 624, through the content interface 620 as shown in FIG. 5A.

In addition, as shown in FIG. 5B, the group interface displays a list of members who have subscribed to the group on the content interface 620 according to the selection of the member view button of the menu interface 610. At this time, when a particular member is selected among the displayed subscription members, the information of the corresponding member is displayed in the form of the friend interface described above.

In addition, as shown in FIG. 5C, the group interface displays a chat window for chatting with a member who has subscribed to the group on the content interface 620 according to the selection of the chat view button of the menu interface 610. At this time, it is possible to communicate with each member.

In addition, as shown in FIG. 5D, the group interface displays a group schedule on the content interface 620 according to the selection of the schedule view button of the menu interface 610, and enables the user to edit the group schedule through the schedule management tool.

In addition, although not shown, the group interface integrates and displays a group image and other digital content according to the selection of the album view button of the menu interface 610, and enables the user to edit digital content through the content management tool. In addition, according to the selection of a voting button of the menu interface 610, the group interface enables the user to check ongoing voting status, to directly perform the voting, or to generate a new voting.

In this way, the social network management support server and the user terminal according to the present invention are configured to manage not only the friend relationship between individual users, but also the friend relationship between group members, thereby improving user's convenience through the easy user interface.

The social network management support technique according to the exemplary embodiment of the present invention described above may also be implemented in the form of a recording medium including instructions executable by a computer, such as a program module executed by the computer. Computer readable media may be any available media that may be accessed by a computer, and includes both volatile and non-volatile media, and removable and non-removable media. In addition, the computer readable media may include both computer storage media and communication media. The computer storage media includes both volatile and non-volatile, and removable and non-removable media, which are implemented in any method or technology for storing information such as computer readable instructions, data structures, program modules, or other data. The communication media typically include computer readable instructions, data structures, program modules, or other data in a modulated data signal such as a carrier wave, or other transmission mechanism, and include any information delivery media. Although the methods and system of the present invention have been described in connection with specific exemplary embodiment, some or all of the components or operations may be implemented using a computer system having a general purpose hardware architecture.

The above description of the present invention is for illustration, and it will be understood that those skilled in the art to which the present disclosure pertains may easily transform the present disclosure in other specific forms without departing from the technical spirit or essential features thereof. Therefore, it should be understood that the above-described exemplary embodiments are illustrative in all respects and not restrictive. For example, each component described as a single type may be implemented in a distributed manner, and similarly, components described as distributed may be implemented in a combined form.

The scope of the present invention is indicated by the following claims rather than the above detailed description, and all changes or modifications derived from the meaning and scope of the claims and equivalent concepts should be interpreted as being included in the claims of the present invention.

What is claimed is:

1. A social network management support server for supporting management of a social network among users, the social network management support server comprising:
a communication module performing data communication;
a memory storing a server-side social network relationship management program; and
a processor executing the server-side social network relationship management program stored in the memory,
wherein, in response to executing of the program, the processor stores user personal information, and personal data registered by the users, in a database by matching with user identification information; stores group information, and group data registered by members of a group, in the database by matching with group identification information; and stores friend relationship information, and friend relationship data registered by the users establishing a friend relationship, by matching with friend relationship identification information,
wherein the personal data includes one or more of a friend list, a personal schedule, a personal memo, and digital content, which are registered by the users; the group data includes one or more of a group schedule, a group post, group chat data, and the digital content, which are registered by the members of the group; the friend relationship information includes identification information of two users establishing the friend relationship, and includes, as information about a type of friend relationship establishment, information of whether the friend relationship is a friend relationship between individuals who have established the friend relationship by an acceptance of the friend relationship establishment of the two users, or a friend relationship between group members who have automatically established the friend relationship between the group members at a time of group member registration; and the friend relationship data includes one or more of a schedule between friends, a post between friends, chat data between friends, exchange between friends, and the digital content, which are registered by the two users.

2. The social network management support server of claim 1, wherein
the processor generates highlight information for emphasizing a vocabulary or sentence positioned between two special symbols in an instant message received from a sender terminal by the communication module, and
the communication module transmits the highlight information to a receiver terminal and the sender terminal.

3. The social network management support server of claim 2, wherein
the special symbol includes any one or a plurality of special symbols from a group including “˜, !, @, #, $, %, \hat{ }, &, *, _, +, =”, and
each special symbol includes the highlight information different from each other.

4. The social network management support server of claim 3, wherein the highlight information includes a font attribute determined according to a type of the special symbol, in which the font attribute includes at least one of a font type, a font style, a font thickness, a font size, and a font color.

5. The social network management support server of claim 1, wherein the processor generates new friend relationship identification information in a case of creating a first friend relationship in which the friend relationship is established through the acceptance of the friend relationship establishment of the two users, or in a case of establishing a second friend relationship in which, as the user is registered as a member of a first group, the friend relationship is automatically established between the user and each member of the first group where no friend relationship is established with corresponding user.

6. The social network management support server of claim 5, wherein
the processor adds information about the second friend relationship establishment by matching with the friend relationship identification information already generated by creating the first friend relationship when the second friend relationship is established between the two users whose first friend relationship has already been created, or
the processor adds information about the first friend relationship establishment by matching with the friend relationship identification information already generated by creating the second friend relationship when the first friend relationship is established between the two users whose second friend relationship has already been created.

7. The social network management support server of claim 1, wherein the processor stores the friend relationship identification information, in which a first user is included as a chat member, by matching with identification information of the first user, and transmits the information to a user terminal of the first user and a user terminal of a chat partner when the friend relationship data matched with the friend relationship identification information is updated.

8. The social network management support server of claim 1, wherein
the processor outputs a personal data reception notification informing a user terminal of a second user that the personal data has been received from a first user in a case of receiving a personal data transmission request requesting transmission of the personal data to the second user having established a friend relationship with the first user from a user terminal of the first user, and
the processor outputs a group data reception notification informing a user terminal of members of a first group that the group data has been received from the first user in a case of receiving a group data transmission request requesting transmission of the group data to the members of the first group to which the first user has subscribed from the user terminal of the first user.

9. The social network management support server of claim 1, wherein
the user personal information includes one or more of a user ID, contact information, a profile image, and a nickname, and
the group information includes one or more of a group name, a description about the group, group member information, a group profile image, and nickname information of the members in the group.

10. A user terminal performing social network relationship management, the user terminal comprising:
a communication module performing data communication;
a display unit;
a memory storing a user-side social network relationship management program; and
a processor executing the user-side social network relationship management program stored in the memory,
wherein, in response to executing of the program, the processor stores personal information and personal data of a user in a local database; stores friend relationship information and friend relationship data where a friend relationship with the user is established, in the local database by matching with friend relationship identification information; stores group information and group data in the local database by matching with identification information of a group where the user is registered as a member of the group; and outputs the personal data, the friend relationship data, or the group data through a user interface displayed on the display unit,
wherein the personal data includes one or more of a friend list, a personal schedule, a personal memo, and digital content, which are registered in a social network management support server by the user; the group data includes one or more of a group schedule, a group post, group chat data, and the digital content, which are registered in the social network management support server by members of the group; the friend relationship information includes identification information of two users establishing the friend relationship, but includes, as information about a type of friend relationship establishment, information of whether the friend relationship is a friend relationship between individuals who have established the friend relationship by an acceptance of the friend relationship establishment of the two users, or a friend relationship between group members who have automatically established the friend relationship between the group members at a time of group member registration; and the friend relationship data includes one or more of a schedule between friends, a post between friends, chat data between friends, exchange between friends, and the digital content, which are registered by the two users.

11. The user terminal of claim 10, wherein
the processor generates highlight information for emphasizing a vocabulary or sentence positioned between two special symbols in an instant message created by the sender, and
the communication module transmits the highlight information to a receiver terminal or to the social network management support server so as to allow the receiver terminal to receive the highlight information.

12. The user terminal of claim 11, wherein
the special symbol includes any one or a plurality of special symbols in a group including “˜, !, @, #, $, %, \hat{ }, &, *, −, _, +, =”, and
each special symbol includes the highlight information different from each other.

13. The user terminal of claim 12, wherein the highlight information includes a font attribute determined according to a type of the special symbol, in which the font attribute includes at least one of a font type, a font style, a font thickness, a font size, and a font color.

14. The user terminal of claim 10, wherein the processor displays, as the user interface, a menu interface that performs access processing for one or more of all friends with established friend relationships, all groups registered by members, all chat data included by the user as a chat member, and all schedules of user participation; and a content interface in which a result corresponding to the access processing selected by the user is displayed through the menu interface,
wherein the menu interface includes a friend/group view button, a chat view button, and a schedule view button; displays on the content interface one or more of the friend lists in which the friend relationship is established with the user, a list of users who have received a friend request, and a list of users recommended as a friend, according to activation of the friend/group view button, or displays on the content interface one or more of a list of groups to which the user is subscribed, a list of groups to which the user is invited to subscribe, and a list of recommended groups; displays on the content interface a list of chat windows with other users in which the user is included as the chat member according to activation of the chat view button; and displays integrally on the content interface the schedule registered by the user, the schedule registered by the group to which the user is subscribed, and the schedule between the user and the friend who has established the friend relationship, according to activation of the schedule view button.

15. The user terminal of claim 14, wherein the menu interface further includes an album view button, and displays integrally on the content interface the digital content included in the personal data, the digital content included in the group data, or the digital content included in the friend relationship data, according to activation of the album view button.

16. The user terminal of claim 14, wherein the menu interface further includes an exchange display button, and displays on the content interface a list of gift items or mobile payment items that are exchanged or scheduled to be exchanged between the user and the other users according to activation of the exchange display button.

17. The user terminal of claim 14, wherein
the menu interface is displayed at a fixed position in a part of an area of the display unit, and
the friend/group view button, the chat view button, and the schedule view button are disposed on a same menu bar.

18. The user terminal of claim 14, wherein the menu interface further includes a view switching button for switching between a friend list view and a group list view in a state where the friend/group view button is activated.

19. The user terminal of claim 14, wherein the processor receives a friend registration establishment request of the user through the content interface displayed according to the activation of the friend/group view button, or receives the group member registration establishment request of the user to transmit to the social network management support server.

20. The user terminal of claim 14, wherein
the processor transmits the personal data to the social network management support server in a case of receiving a personal data transmission request requesting transmission of the personal data to a second user with whom a first user who is a user of the user terminal has established the friend relationship, through the content interface displayed according to the activation of the friend/group view button, and
the processor transmits the group data to the social network management support server in a case of receiving a group data transmission request requesting transmission of the group data to members of a first group to which the first user has subscribed, through the content interface displayed according to the activation of the friend/group view button.

21. The user terminal of claim 14, wherein
the processor displays the personal data transmitted through the social network management support server by the user terminal of a second user with whom a first user who is a user of the user terminal has established the friend relationship, through the content interface displayed according to the activation of the friend/group view button, and
the processor displays the group data transmitted through the social network management support server by a member of a first group to which the first user has subscribed, through the content interface displayed according to the activation of the friend/group view button.

22. The user terminal of claim 14, wherein
the processor activates the friend interface that displays information about corresponding friend, when a particular friend is selected by the user, in a case of activating a friend list view displaying on the content interface one or more of the friend lists in which the friend relationship is established with the user, the list of users who have received the friend request, and the list of users recommended as the friend, according to the activation of the friend/group view button, but
the friend interface displays a friend type display icon indicating the type of the friend relationship with the corresponding friend.

23. The user terminal of claim 14, wherein
the processor activates the friend interface that displays information about corresponding friend, when a particular friend is selected by the user, in a case of activating a friend list view displaying on the content interface one or more of the friend lists in which the friend relationship is established with the user, the list of users who have received the friend request, and the list of users recommended as the friend, according to the activation of the friend/group view button, but
the friend interface displays a common subscription group when there is a group in which the user and the corresponding friend are registered as members in common.

24. The user terminal of claim 14, wherein
the processor activates the friend interface that displays information about corresponding friend, when a particular friend is selected by the user, in a case of activating a friend list view displaying on the content interface one or more of the friend lists in which the friend relationship is established with the user, the list of users who have received the friend request, and the list of users recommended as the friend, according to the activation of the friend/group view button, but
the friend interface displays on a single screen a chat window interface displaying a chat window capable of chatting with the other users, and a chat status interface displaying the status of one or more participating chat windows, by separating areas from each other, and displays the chat window on the chat window interface when any of chat window icons displayed on the chat status interface is selected.

25. The user terminal of claim 24, wherein a chat status interface displays a chat window icon displaying a chat with a user having a friend relationship and a chat window icon displaying a chat with the members of the group to which the user is subscribed as the member.

26. The user terminal of claim 24, wherein a chat status interface displays all together with a chat window icon displaying a chat with a user having a first friend relationship in which the friend relationship is established through the acceptance of the friend relationship establishment of the two users; a chat window icon displaying a chat with a user having a second friend relationship in which, as the user is registered as a member of a first group, the friend relationship is automatically established between the user and each member of the first group where no friend relationship is established with corresponding user; and a chat window icon displaying a chat with the members of the group to which the user is subscribed as the member.
